(19) United States
(12) Patent Application Publication
(10) Pub. No.: US 2026/0164466 A1
(43) Pub. Date: Jun. 11, 2026

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/710,018

(22) PCT Filed: Dec. 10, 2021
(86) PCT No.: PCT/CN2021/137221

§ 371 Date: May 14, 2024

(51) Int. Cl. H04W 74/0833; H04W 68/00

(52) U.S. Cl. CPC H04W 74/0833; H04W 68/00

(57) ABSTRACT

Embodiments of the present disclosure relate to methods, devices and computer readable media for communication. A terminal device receives, a paging message from a network device in a radio access network, the paging message comprising a first indication indicating that a MT-SDT is to be performed for the terminal device; and determines whether a random access based MT-SDT or a configured grant based MT-SDT is performed for the terminal device. In this way, a MT-SDT procedure can be performed.

### TECHNICAL FIELD

Embodiments of the present disclosure generally relate to the field of telecommunication, and in particular, to methods, devices and computer storage media of communication for small data transmission (SDT).

### BACKGROUND

Typically, a terminal device in an inactive state may still have small and infrequent data traffic to be transmitted. Until the third generation partnership project (3GPP) Release 16, the inactive state cannot support data transmission, and the terminal device has to resume connection (i.e., enter a connected state) for any downlink and uplink data. This will result in unnecessary power consumption and signaling overhead.

In this event, 3GPP Release 17 has approved small data transmission (SDT) in the inactive state. SDT is a procedure allowing data transmission while remaining in an inactive state (i.e. without transitioning to a connected state). Thereby, the signaling overhead can be reduced. In 3GPP Release 17, only mobile originated SDT (MO-SDT) is specified. MO-SDT means that the triggering of SDT in inactive state is due to arriving of uplink (UL) data. In 3GPP Release 18, one of the potential enhancement aspects is mobile terminated SDT (MT-SDT). MT-SDT means that the triggering of SDT in inactive state is due to arriving of downlink (DL) data. Up to now, MT-SDT related techniques are incomplete and to be further developed.

### SUMMARY

In general, embodiments of the present disclosure provide methods, devices and computer storage media of communication for MT-SDT.

In a first aspect, there is provided a method of communication. The method comprises: receiving, at a terminal device, a paging message from a network device in a radio access network, the paging message comprising a first indication indicating that a MT-SDT is to be performed for the terminal device; and determining whether a random access based MT-SDT or a configured grant based MT-SDT is performed for the terminal device.

In a second aspect, there is provided a method of communication. The method comprises: transmitting, at a network device in a radio access network, a paging message to a terminal device, the paging message comprising a first indication indicating that a MT-SDT is to be performed for the terminal device; and receiving, from the terminal device, an initial uplink transmission of the MT-SDT via a random access resource or a configured grant resource.

In a third aspect, there is provided a terminal device. The terminal device comprises a processor and a memory coupled to the processor. The memory stores instructions that when executed by the processor, cause the terminal device to perform the method according to the first aspect of the present disclosure.

In a fourth aspect, there is provided a network device. The network device comprises a processor and a memory coupled to the processor. The memory stores instructions that when executed by the processor, cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram of a user plane (UP) protocol stack in which some embodiments of the present disclosure can be implemented;

FIG. 1C illustrates a schematic diagram of a control plane (CP) protocol stack in which some embodiments of the present disclosure can be implemented;

FIG. 2A illustrates a schematic diagram illustrating a radio access network (RAN) paging procedure in which some embodiments of the present disclosure can be implemented;

FIG. 2B illustrates a schematic diagram illustrating a SDT procedure for one-shot in which some embodiments of the present disclosure can be implemented;

FIG. 2C illustrates a schematic diagram illustrating a SDT procedure comprising initial transmission and subsequent transmission in which some embodiments of the present disclosure can be implemented;

FIG. 3 illustrates a schematic diagram illustrating a process of communication for MT-SDT according to embodiments of the present disclosure;

FIG. 4A illustrates a flowchart illustrating an example process of determining a MT-SDT procedure according to Embodiment 1 of the present disclosure;

FIG. 4B illustrates a schematic diagram illustrating an example determination of a first time interval according to the process of FIG. 4A;

FIG. 5A illustrates a flowchart illustrating an example process of determining a MT-SDT procedure according to Embodiment 2 of the present disclosure;

FIG. 5B illustrates a schematic diagram illustrating an example determination of first and second time intervals according to the process of FIG. 5A;

FIG. 6A illustrates a flowchart illustrating an example process of determining a MT-SDT procedure according to Embodiment 3 of the present disclosure;

FIG. 6B illustrates a flowchart illustrating an example process of determining a MT-SDT procedure according to Embodiment 4 of the present disclosure;

FIG. 7A illustrates a flowchart illustrating an example process of determining a MT-SDT procedure according to Embodiment 5 of the present disclosure;

FIG. 7B illustrates a flowchart illustrating an example process of performing a configured grant (CG) based MT-SDT procedure according to Embodiment 6 of the present disclosure;

FIG. 7C illustrates a flowchart illustrating an example process of performing a random access (RA) based MT-SDT procedure according to Embodiment 7 of the present disclosure;

FIG. 8 illustrates an example method of communication implemented at a terminal device in accordance with some embodiments of the present disclosure;

FIG. 9 illustrates an example method of communication implemented at a network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

Currently, there are various applications that involve exchange of small and infrequency data. For example, in some applications of mobile devices, SDT may involve traffic from Instant Messaging (IM) services, heart-beat or keep-alive traffic, for example, from IM or email clients and other services, push notifications in various applications, traffic from wearables (including, for example, periodic positioning information), and/or the like. In some applications of non-mobile devices, SDT may involve sensor data (e.g., temperature, pressure readings transmitted periodically or in an event-triggered manner in an IoT network), metering and alerting information sent from smart meters, and/or the like.

Recently, it has been proposed to support a paging-triggered SDT (MT-SDT). Specifically, a MT-SDT triggering mechanism is supported for UEs in RRC_INACTIVE and a RA based SDT and a CG based SDT are supported as an uplink (UL) response. Further, a MT-SDT procedure for initial downlink (DL) data reception and subsequent UL/DL data transmissions in RRC_INACTIVE is also supported. However, MT-SDT related techniques are incomplete and to be further developed.

In view of this, embodiments of the present disclosure provide solutions of communication for MT-SDT to overcome the above and other potential issues. Principles and implementations of the present disclosure will be described in detail below with reference to the figures.

### Example of Communication Environment

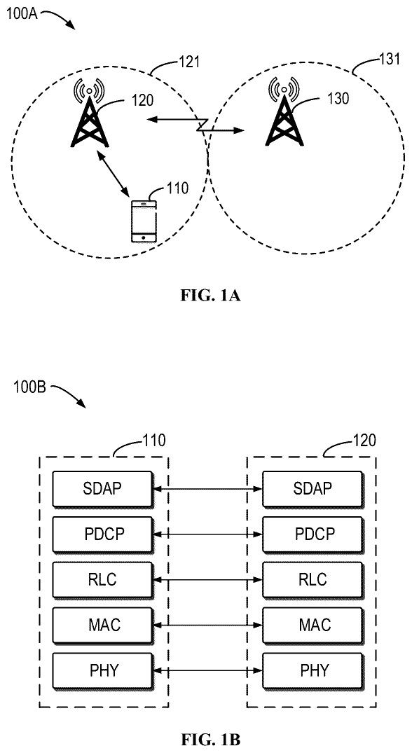

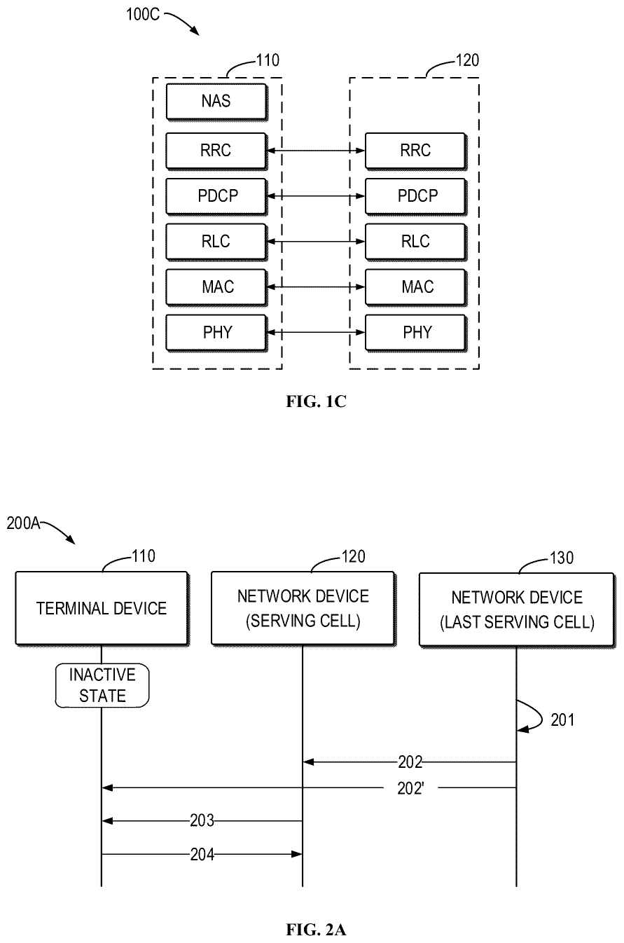

FIG. 1A illustrates a schematic diagram of an example communication network 100 in which some embodiments of the present disclosure can be implemented. As shown in FIG. 1A, the communication network 100 may include a terminal device 110 and a plurality of network devices. For illustration, a network device 120 and a further network device 130 are shown as the plurality of network devices. The network devices 120 and 130 provide respective cells 121 and 131 to serve a terminal device. In the example of FIG. 1A, the terminal device 110 is located within the cell 121 of the network device 120, and the terminal device 110 may communicate with the network device 120. The cell 121 may be referred to as a serving cell of the terminal device 110.

In the context of the present application, assuming that the network device 130 is the last serving network device for the terminal device 110. In other words, the network device 130 instructs the terminal device 110 to enter into an inactive state. The last serving network device keeps the context of the terminal device 110 and associated NG connection with the serving authentication management function (AMF) and user plane function (UPF) in the core network (CN) (not shown). The network device 120 is a neighboring network device of the network device 130, and cell 121 of the network device 120 is included in a RAN-based notification area (RNA) of the terminal device 110. The RNA of the terminal device 110 is configured by the last serving network device, i.e. the network device 130. The RNA may cover a single cell or multiple cells, and may be contained within a CN registration area, and Xn connectivity may be available within the RNA. The terminal device 110 may move within the RNA without notifying the network.

It is to be understood that the number of devices in FIG. 1A is given for the purpose of illustration without suggesting any limitations to the present disclosure. The communication network 100 may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network devices 120 and 130 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

Communication in a direction from the terminal device 110 towards the network devices 120 or 130 is referred to as UL communication, while communication in a reverse direction from the network devices 120 or 130 towards the terminal device 110 is referred to as DL communication. The terminal device 110 can move amongst the cells of the network devices 120 or 130 and possibly other network devices. In UL communication, the terminal device 110 may transmit UL data and control information to the network devices 120 or 130 via a UL channel. In DL communication, the network devices 120 or 130 may transmit DL data and control information to the terminal device 110 via a DL channel.

The communications in the communication network 100 can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure.

As shown in FIG. 1B, in the UP, each of the terminal device 110, the network device 120 and the network device 130 may comprise an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110, the network device 120 and the network device 130 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. In the context of the present disclosure, a DRB may be configured as supporting a transmission in an inactive state (i.e., supporting SDT). Of course, a DRB may also be configured as not supporting a transmission in an inactive state. A SRB may be configured as supporting a transmission in an inactive state. Of course, a SRB may also be configured as not supporting a transmission in an inactive state.

Three types of SRBs are defined in a RRC layer, i.e., SRB0, SRB1 and SRB2. SRB0 uses a CCCH for RRC connection establishment or re-establishment. SRB1 uses a DCCH and is established when RRC connection is established. SRB2 uses a DCCH and is established during RRC reconfiguration and after initial security activation.

In addition, a protocol data unit (PDU) session may be established at the NAS layer of the terminal device 110 to transmit data to CN or receive data from CN. A PDU session may correspond to a SDAP entity, and may comprise a plurality of quality of service (QoS) flows. In the context of the present disclosure, a QoS flow may be configured as supporting a transmission in an inactive state. Of course, a QoS flow may also be configured as not supporting a transmission in an inactive state.

In some scenarios, if the network device 130 as the last serving network device receives DL data from the UPF or DL signaling associated with the terminal device 110 from the AMF (except the UE context release command message) while the terminal device 110 is in an inactive state, the network device 130 may page in the cells corresponding to the RNA. This procedure may be called as RAN paging. During the RAN paging, the network device 130 may transmit XnAP RAN paging message to one or more neighbor network devices if the RNA includes cells of the one or more neighbor network devices.

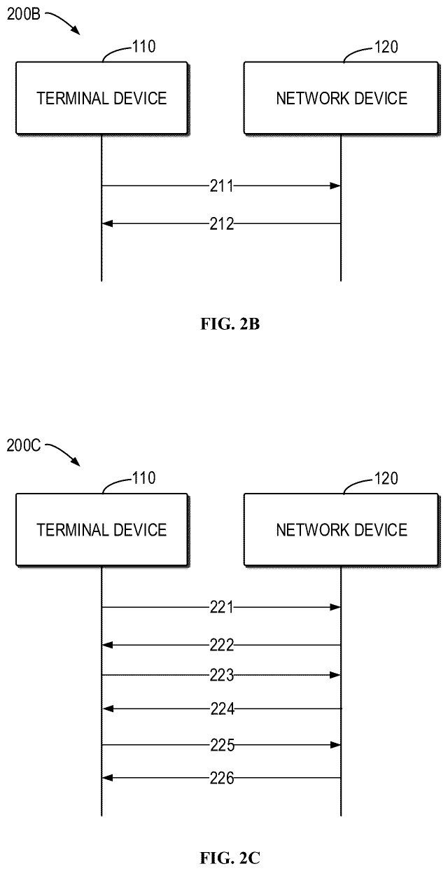

FIG. 2A illustrates a schematic diagram illustrating a RAN paging procedure 200A in which some embodiments of the present disclosure can be implemented. For the purpose of discussion, the process 200A will be described with reference to FIG. 1. The process 200A may involve the terminal device 110, the network device 120 and the network device 130 as illustrated in FIG. 1.

As shown in FIG. 2A, the terminal device 110 is in an inactive state. The network device 130 may determine 201 whether a RAN paging trigger event occurs. For example, if the network device 130 receives DL data from the UPF or DL signaling associated with the terminal device 110 from the AMF (except the UE context release command message), the network device 130 may determine that the RAN paging trigger event occurs. Of course, the RAN paging trigger event is not limited to this example, and may be in any other suitable forms.

If determining that the RAN paging trigger event occurs, the network device 130 may page in the cells corresponding to the RNA. For convenience, assuming that the network device 120 is in the cells corresponding to the RNA, and the following description is made by taking the network device 120 as an example. In this case, the network device 130 may transmit 202 a XnAP RAN paging message to the network device 120 and other network devices in the RNA. The network device 130 may also transmit 202′ a paging message to the terminal device 110.

Upon receipt of the XnAP RAN paging message, the network device 120 may transmit 203 a paging message to the terminal device 110. In some embodiments, the paging message may comprise an inactive radio network temporary identifier (I-RNTI). Of course, the paging message may also comprise any other suitable information. If the terminal device 110 has been successfully reached, the terminal device 110 may attempt to resume 204 from the inactive state. So far, a RAN paging procedure is done. It is to be understood that the RAN paging procedure 200A may comprise more or less steps, and is not limited to the above example.

In some scenarios, when the terminal device 110 in an inactive state has small and infrequency data traffic to be transmitted, the terminal device 110 may initiate a SDT procedure, i.e., MO-SDT. As mentioned above, SDT is a procedure allowing data transmission while remaining in an inactive state (i.e. without transitioning to a connected state). In some embodiments, SDT is enabled on a radio bearer basis and is initiated by a terminal device only if less than a configured amount of UL data awaits transmission across all radio bearers for which SDT is enabled and measured reference signal receiving power (RSRP) in the cell is above a configured threshold.

FIG. 2B illustrates a schematic diagram illustrating a SDT procedure 200B for one-shot in which some embodiments of the present disclosure can be implemented. For the purpose of discussion, the process 200B will be described with reference to FIG. 1. The process 200B may involve the terminal device 110 and the network device 120 serving the terminal device 110 as illustrated in FIG. 1. This is merely an example, and it is to be understood that the process 200B may also be performed between the terminal device 110 and the network device 130.

As shown in FIG. 2B, the terminal device 110 in an inactive state may transmit 211, to the network device 120, a RRC resume request with UL data associated with the data traffic. For example, the terminal device 110 may transmit the RRC resume request with UL data in Msg A of a 2-step RACH procedure or in Msg3 of a 4-step RACH procedure. Of course, the terminal device 110 may also transmit the RRC resume request with UL data in a configured grant (CG) resource. Upon receipt of the RRC resume request and the UL data, the network device 120 may transmit 212 a RRC release message with DL data corresponding to the UL data to the terminal device 110. For example, the network device 120 may transmit the RRC release message with the DL data in Msg B of a 2-step RACH procedure or in Msg4 of a 4-step RACH procedure. Or the network device 120 may transmit the RRC release message with DL data as response of the transmission at the CG resource. So far, the SDT procedure 200B ends.

FIG. 2C illustrates a schematic diagram illustrating a SDT procedure 200C comprising initial transmission and subsequent transmission in which some embodiments of the present disclosure can be implemented. As shown in FIG. 2C, the terminal device 110 in an inactive state may transmit 221, to the network device 120, a RRC resume request with UL data and a BSR. For example, the terminal device 110 may transmit the RRC resume request with the UL data and the BSR in Msg A of a 2-step RACH procedure or in Msg3 of a 4-step RACH procedure. Of course, the terminal device 110 may also transmit the RRC resume request with UL data in a configured grant (CG) resource. The RRC resume request may comprise a resume cause. Upon receipt of the RRC resume request with the UL data and the BSR, the network device 120 may transmit 222 an indication of subsequent transmission to the terminal device 110. For example, the network device 120 may transmit an explicit RRC message indicating the subsequent transmission. As another example, the network device 120 may transmit an UL grant for further transmission so as to implicitly indicating the subsequent transmission. In some embodiments, the network device 120 may transmit DL data with the indication to the terminal device 110. So far, the initial transmission is done.

Based on the indication, the terminal device 110 may transmit 223 further UL data and BSR to the network device 120, for example, based on a dynamic grant or configured grant. Then the network device 120 may transmit 224 an UL grant for dynamic grant to the terminal device 110. In some embodiments, the network device 120 may transmit DL data with the UL grant to the terminal device 110. Based on the UL grant from the network device 120, the terminal device 110 may transmit 225 remaining UL data to the network device 120. Accordingly, the network device 120 may transmit 226 RRC release message to the terminal device 110. So far, subsequent transmission is done. That is, the SDT procedure 200C ends. It is to be understood that the SDT procedure 200C may comprise more or less steps in the subsequent transmission.

### Example Implementation of Determination of MT-SDT Procedure

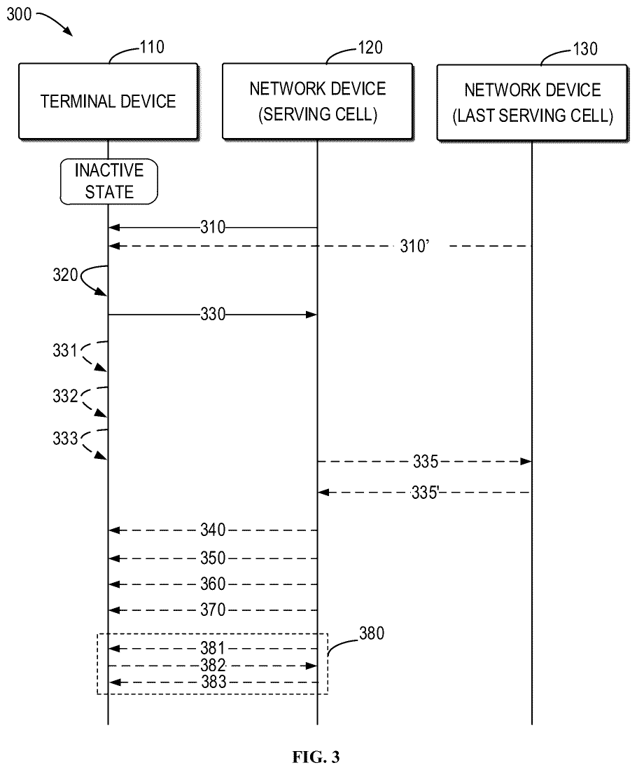

Embodiments of the present disclosure provide solutions for determining and performing a MT-SDT procedure. The detailed description will be given below in connection with FIGS. 3 to 7C.

FIG. 3 illustrates a schematic diagram illustrating a process 300 of communication for MT-SDT according to embodiments of the present disclosure. For the purpose of discussion, the process 300 will be described with reference to FIG. 1. The process 300 may involve the terminal device 110, the network device 120 and the network device 130 as illustrated in FIG. 1. Assuming that the network device 120 is the current serving network device (i.e., providing a serving cell) for the terminal device 110 and the network device 130 is the last serving network device (i.e., providing the last serving cell) for the terminal device 110, and that the terminal device 110 has entered into an inactive state under instruction of the last serving network device. Further, assuming that the network device 130 initiates a RAN paging in cells corresponding to RNA, and the network device 120 receives the RAN paging from the network device 130. Assuming that the terminal device 110 resides in the cell 121.

As shown in FIG. 3, the network device 120 transmits 310, to the terminal device 110, a paging message comprising an indication (for convenience, also referred to as a first indication herein) indicating that a MT-SDT is to be performed for the terminal device 110. The network device 130 may also transmit 310′ the paging message to the terminal device 110. For example, the RAN paging may comprise information on MT-SDT for the terminal device 110. Upon reception of the RAN paging, the network device 120 may transmit the first indication in the paging message to the terminal device 110. It is to be understood that the transmission of the first indication may be triggered by any other suitable triggering events, and the present disclosure does not limit this aspect.

As the terminal device 110 resides in the cell 121, the terminal device 110 may only response to the paging message from the network device 120. Upon reception of the paging message from the network device 120, the terminal device 110 determines 320 whether a RA based MT-SDT or a CG based MT-SDT is performed for the terminal device 110. For the RA based MT-SDT, an initial UL transmission of MT-SDT is transmitted in Msg 3 or Msg A. For the CG based MT-SDT, an initial UL transmission of MT-SDT is transmitted in a CG resource.

In some embodiments, upon reception of the paging message indicating MT-SDT, a RRC layer of the terminal device 110 may determines that MT-SDT procedure is triggered, and the RRC layer of the terminal device 110 may indicate to a MAC layer of the terminal device 110 that the MT-SDT is triggered, and the MAC layer may determine whether the RA based MT-SDT or the CG based MT-SDT is performed for the terminal device 110. In some embodiments, the MAC layer may skip the serving cell RSRP check and/or data volume check for MT-SDT, and then perform a selection between the RA based MT-SDT and the CG based MT-SDT.

In some embodiments, the terminal device 110 may perform the determination 320 based on at least one of the following: information of CG resource(s) configured for SDT, information of RA resource(s) configured for SDT, information of CG resource(s) dedicated for MT-SDT, or information of RA resource(s) dedicated for MT-SDT. In some embodiments, the terminal device 110 may receive, from the network device 120, one or more configurations indicating at least one of the following: the information of CG resource(s) configured for SDT, the information of RA resource(s) configured for SDT, the information of CG resource(s) dedicated for MT-SDT, or the information of RA resource(s) dedicated for MT-SDT.

In some embodiments, the CG based MT-SDT may have a higher priority than the RA based MT-SDT. In these embodiments, the terminal device 110 may determine whether a CG resource is available for SDT, i.e., whether there is valid CG resource. If there is the CG resource available for SDT, the terminal device 110 may determine that the CG based MT-SDT is performed. If there is no CG resource available for SDT, the terminal device 110 may determine that the RA based MT-SDT is performed.

For illustration, some example embodiments for the determination 320 will be described in details in connection with Embodiments 1 to 7.

### Embodiment 1

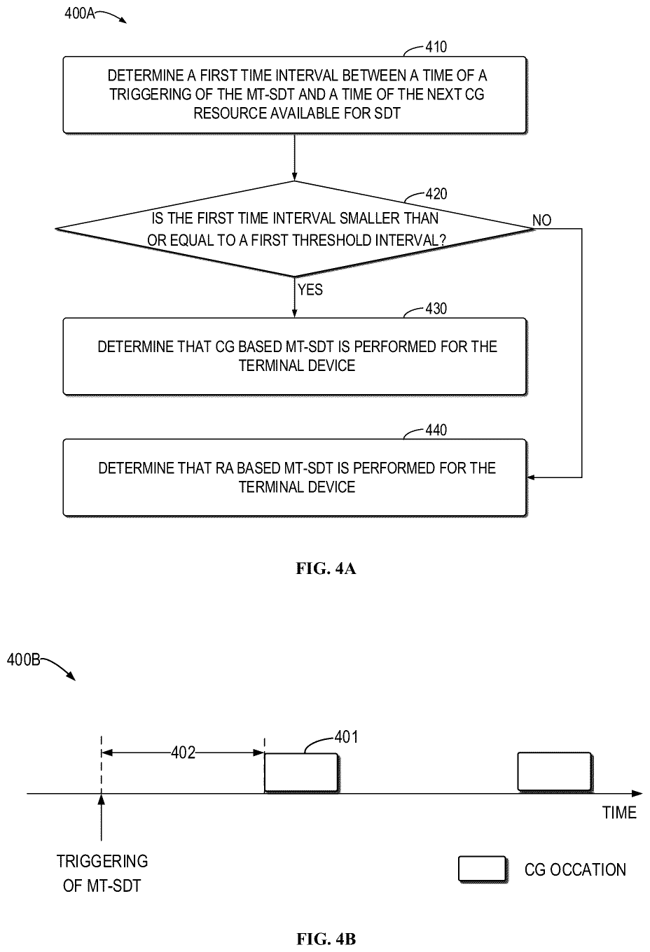

Current CG-SDT configuration is designed for MO-SDT, and thus a periodicity in the CG-SDT configuration will be long considering a service requirement. If the CG-SDT configuration is used to transmit the initial UL transmission of the MT-SDT, a big delay may be introduced. In addition, if a terminal device does not respond to the RAN paging message for a long time, a network device will page the terminal device in a larger area, and even start a core network (CN) paging. In view of this, Embodiment 1 provides a solution of determining a MT-SDT procedure to solve the above and other potential issues. This embodiment will be described with reference to FIGS. 4A and 4B.

FIG. 4A illustrates a flowchart illustrating an example process 400A of determining a MT-SDT procedure according to Embodiment 1 of the present disclosure. For example, the method 400A may be performed at the terminal device 110 as shown in FIG. 1. For the purpose of discussion, in the following, the method 400A will be described with reference to FIG. 1. It is to be understood that the method 400A may include additional blocks not shown and/or may omit some blocks as shown, and the scope of the present disclosure is not limited in this regard.

As shown in FIG. 4A, at block 410, the terminal device 110 may determine a time interval (for convenience, also referred to as a first time interval herein) between a time of a triggering of the MT-SDT (i.e. a time of the reception of the paging message) and a time of a next CG resource available for SDT. FIG. 4B illustrates a schematic diagram 400B illustrating an example determination of a first time interval according to the process of FIG. 4A. As shown in FIG. 4B, starting from a triggering of MT-SDT, a next available CG resource for SDT is on a CG occasion 401. Then a time interval 402 from the triggering of MT-SDT to the CG occasion 401 may be determined.

Return to FIG. 4A, at block 420, the terminal device 110 may determine whether the first time interval is smaller than or equal to a first threshold interval. In some embodiments, the terminal device 110 may receive, from the network device 120, a configuration (for convenience, also referred to as a first configuration herein) indicating the first threshold interval. For example, the terminal device 110 may receive the first configuration in system information from the network device 120. As another example, the terminal device 110 may receive the first configuration in a RRC message (for example, a RRC release message or any other suitable messages) from the network device 120. Of course, any other suitable ways are also feasible.

If the first time interval is smaller than or equal to the first threshold interval, the process 400A proceeds to block 430. At block 430, the terminal device 110 may determine that the CG based MT-SDT is performed.

If the first time interval is greater than the first threshold interval, the process 400A proceeds to block 440. At block 440, the terminal device 110 may determine that the RA based MT-SDT is performed. In some embodiments where the RA based MT-SDT is performed, the terminal device 110 may store information on the CG based MT-SDT not performed for the terminal device 110, and report the stored information to the network device 120. In some embodiments, the stored information may comprise the first time interval being greater than the first threshold interval, i.e., a cause of long latency. In some embodiments, the stored information may comprise the first time interval, i.e., an actual length of latency.

With the solution of Embodiment 1, a latency of the CG based MT-SDT may be guaranteed.

### Embodiment 2

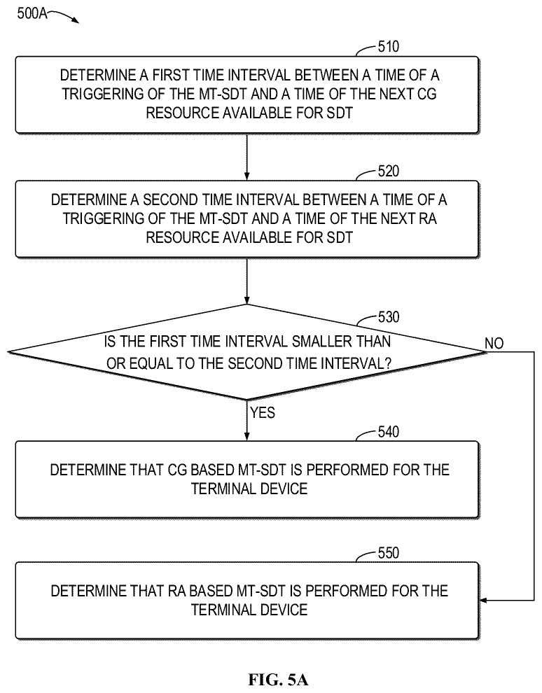

This embodiment is an alternative for Embodiment 1. This embodiment will be described with reference to FIGS. 5A and 5B.

FIG. 5A illustrates a flowchart illustrating an example process 500A of determining a MT-SDT procedure according to Embodiment 2 of the present disclosure. For example, the method 500A may be performed at the terminal device 110 as shown in FIG. 1. For the purpose of discussion, in the following, the method 500A will be described with reference to FIG. 1. It is to be understood that the method 500A may include additional blocks not shown and/or may omit some blocks as shown, and the scope of the present disclosure is not limited in this regard.

As shown in FIG. 5A, at block 510, the terminal device 110 may determine the first time interval between the time of a triggering of the MT-SDT (i.e. the time of the reception of the paging message) and the time of the next CG resource available for SDT. For example, the next CG resource may be the next available CG occasion.

At block 520, the terminal device 110 may determine a time interval (for convenience, also referred to as a second time interval herein) between the time of a triggering of the MT-SDT (i.e. the time of the reception of the paging message) and a time of a next RA resource available for SDT. For example, the next RA resource may be the next available PRACH occasion, or the next available PUSCH resource for 2-step RACH.

FIG. 5B illustrates a schematic diagram 500B illustrating an example determination of first and second time intervals according to the process of FIG. 5A. As shown in FIG. 5B, starting from a triggering of MT-SDT, the next available CG resource for SDT is on a CG occasion 501. Then a time interval 502 from the triggering of MT-SDT to the CG occasion 501 may be determined. Starting from the triggering of MT-SDT, the next available RA resource for SDT is on a PRACH occasion or PUSCH occasion 503. Then a time interval 504 from the triggering of MT-SDT to the PRACH occasion or PUSCH occasion 503 may also be determined.

Return to FIG. 5A, at block 530, the terminal device 110 may determine whether the first time interval is smaller than or equal to the second time interval. If the first time interval is smaller than or equal to the second time interval, the process 500A proceeds to block 540. At block 540, the terminal device 110 may determine that the CG based MT-SDT is performed.

If the first time interval is greater than the second time interval, the process 500A proceeds to block 550. At block 550, the terminal device 110 may determine that the RA based MT-SDT is performed.

With the solution of Embodiment 2, a latency of the CG based MT-SDT may also be guaranteed. Further, as the first threshold interval is not needed to be configured, signaling overhead may be saved.

### Embodiment 3

Currently, it is unclear whether a RA configuration for SDT or a RA configuration for non-SDT or both can be used for MT-SDT. In case of the RA based MT-SDT, there are the following possibilities. First, only a RA configuration for non-SDT may be used for the RA-based MT-SDT. Second, only a RA configuration for SDT may be used for the RA-based MT-SDT. Third, both RA configurations for non-SDT and for SDT may be used for the RA-based MT-SDT.

In the context of the present disclosure, a RA configuration may comprise RA resources and parameters used for a RA procedure. RA resources may comprise preambles, PRACH occasions and/or PUSCH occasions. RA configuration for SDT refers to a RA configuration which is used for a SDT procedure. RA configuration for non-SDT refers to a RA configuration which is not used for a SDT procedure.

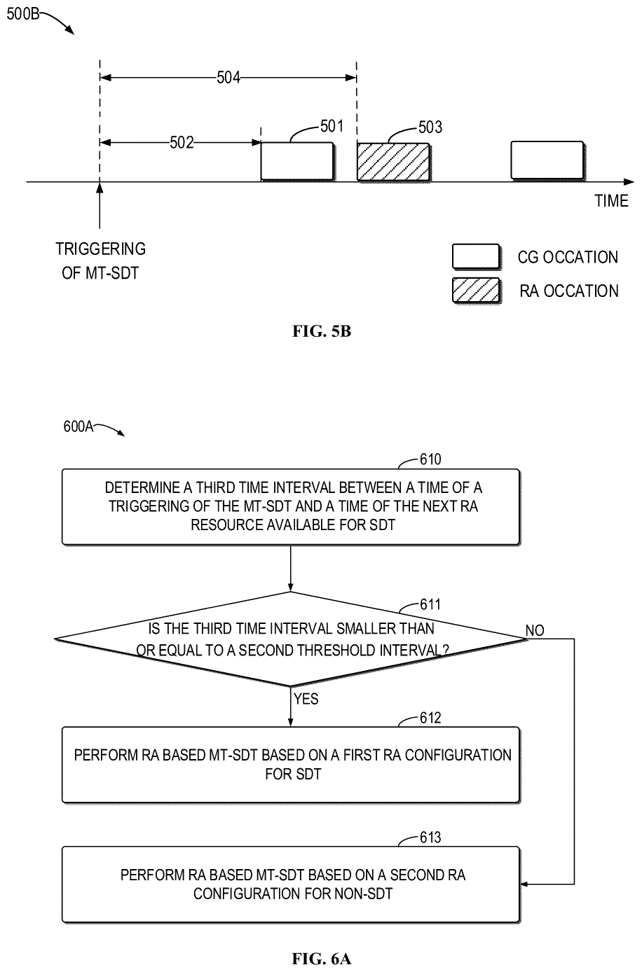

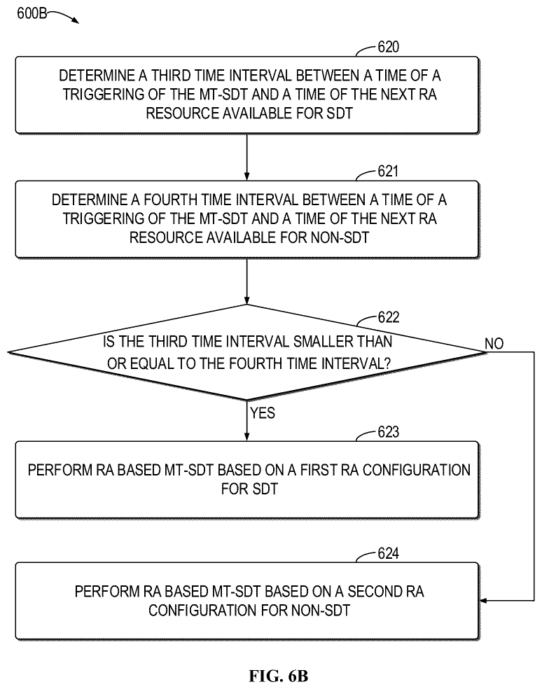

If a RA configuration for SDT is used for MT-SDT, a long latency may be caused. The latency will be long compared with using RA configuration for non-SDT. In view of this, Embodiment 3 provides a solution of determining a MT-SDT procedure to solve the above and other potential issues. In this solution, assuming that both RA configurations for non-SDT and for SDT may be used for the RA-based MT-SDT. This embodiment will be described with reference to FIG. 6A.

FIG. 6A illustrates a flowchart illustrating an example process 600A of determining a MT-SDT procedure according to Embodiment 3 of the present disclosure. For example, the method 600A may be performed at the terminal device 110 as shown in FIG. 1. For the purpose of discussion, in the following, the method 600A will be described with reference to FIG. 1. It is to be understood that the method 600A may include additional blocks not shown and/or may omit some blocks as shown, and the scope of the present disclosure is not limited in this regard. Assuming that the RA based MT-SDT is determined to be performed for the terminal device 110.

As shown in FIG. 6A, at block 610, the terminal device 110 may determine a time interval (for convenience, also referred to as a third time interval herein) between a time of a triggering of the MT-SDT (i.e. a time of the reception of the paging message) and a time of the next RA resource available for SDT. For example, the next RA resource available for SDT may be the next available PRACH occasion or the next available PUSCH occasion.

At block 611, the terminal device 110 may determine whether the third time interval is smaller than or equal to a second threshold interval. In some embodiments, the terminal device 110 may receive, from the network device 120, a configuration (for convenience, also referred to as a second configuration herein) indicating the second threshold interval. For example, the terminal device 110 may receive the second configuration in system information from the network device 120. As another example, the terminal device 110 may receive the second configuration in a RRC message (for example, a RRC release message or any other suitable messages) from the network device 120. Of course, any other suitable ways are also feasible.

If the third time interval is smaller than or equal to the second threshold interval, the process 600A proceeds to block 612. At block 612, the terminal device 110 may perform the RA based MT-SDT based on a RA configuration (for convenience, also referred to as a first RA configuration herein) for SDT.

If the first time interval is greater than the first threshold interval, the process 600A proceeds to block 613. At block 613, the terminal device 110 may perform the RA based MT-SDT based on a RA configuration (for convenience, also referred to as a second RA configuration herein) for non-SDT.

With the solution of Embodiment 3, a latency of the RA based MT-SDT may be guaranteed.

### Embodiment 4

This embodiment is an alternative for Embodiment 3. This embodiment will be described with reference to FIG. 6B.

FIG. 6B illustrates a flowchart illustrating an example process 600B of determining a MT-SDT procedure according to Embodiment 4 of the present disclosure. For example, the method 600B may be performed at the terminal device 110 as shown in FIG. 1. For the purpose of discussion, in the following, the method 600B will be described with reference to FIG. 1. It is to be understood that the method 600B may include additional blocks not shown and/or may omit some blocks as shown, and the scope of the present disclosure is not limited in this regard. Assuming that the RA based MT-SDT is determined to be performed for the terminal device 110.

As shown in FIG. 6B, at block 620, the terminal device 110 may determine the third time interval between the time of the triggering of the MT-SDT and the time of the next RA resource available for SDT. For example, the next RA resource available for SDT may be the next available PRACH occasion or the next available PUSCH resource.

At block 621, the terminal device 110 may determine a time interval (for convenience, also referred to as a fourth time interval herein) between the time of the triggering of the MT-SDT and a time of the next random access resource available for non-SDT.

At block 622, the terminal device 110 may determine whether the third time interval is smaller than or equal to the fourth time interval. If the third time interval is smaller than or equal to the fourth time interval, the process 600B proceeds to block 623. At block 623, the terminal device 110 may perform the RA based MT-SDT based on the first RA configuration for SDT.

If the first time interval is greater than the first threshold interval, the process 600B proceeds to block 624. At block 624, the terminal device 110 may perform the RA based MT-SDT based on the second RA configuration for non-SDT.

With the solution of Embodiment 4, a latency of the RA based MT-SDT may also be guaranteed. Further, as the second threshold interval is not needed to be configured, signaling overhead may be saved.

### Embodiment 5

Currently, a size of a configured CG resource is designed usually for MO-SDT, and thus has a big UL grant size. The UL grant size of CG resource may be several thousand bits, but only a hundred bits will be sufficient for the initial UL transmission of the MT-SDT. Thus, the configured CG resource may be not suitable for MT-SDT as a lot of padding bits may be required to be inserted and waste of UL grants may also be caused.

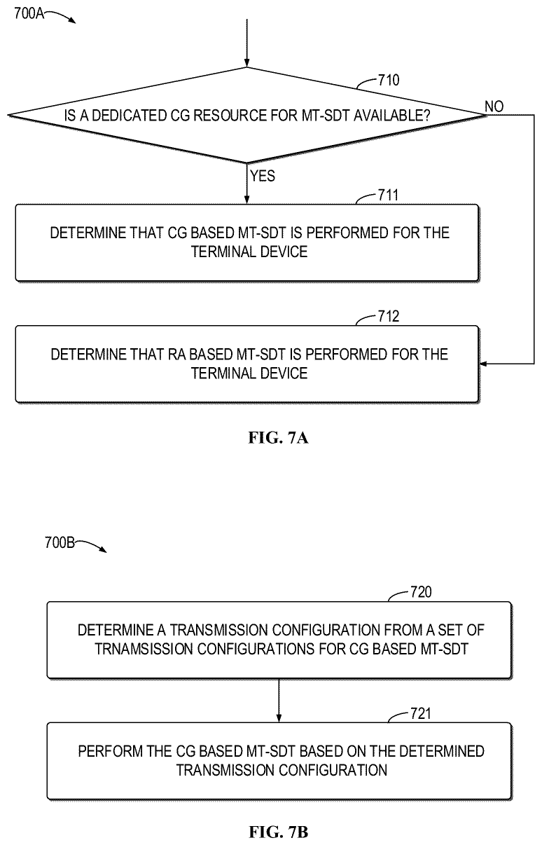

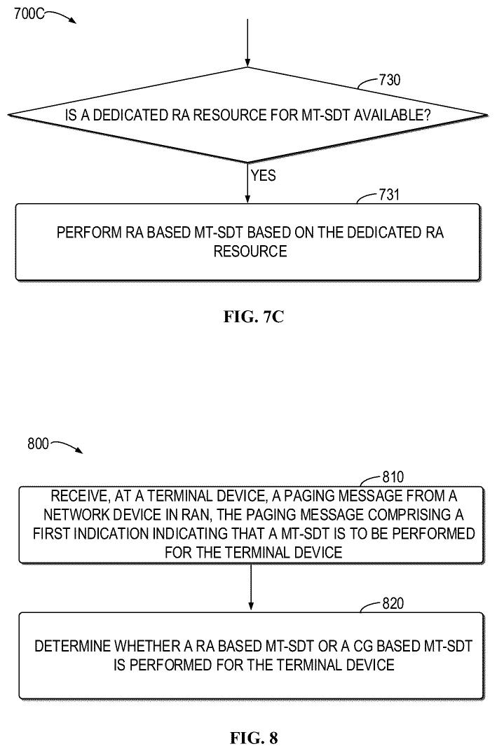

In view of this, Embodiment 5 provides a solution of determining a MT-SDT procedure to solve the above and other potential issues. This embodiment will be described with reference to FIG. 7A.

FIG. 7A illustrates a flowchart illustrating an example process 700A of determining a MT-SDT procedure according to Embodiment 5 of the present disclosure. For example, the method 700A may be performed at the terminal device 110 as shown in FIG. 1. For the purpose of discussion, in the following, the method 700A will be described with reference to FIG. 1. It is to be understood that the method 700A may include additional blocks not shown and/or may omit some blocks as shown, and the scope of the present disclosure is not limited in this regard.

As shown in FIG. 7A, at block 710, the terminal device 110 may determine whether a dedicated CG resource for MT-SDT is available. In some embodiments, the dedicated CG resource for MT-SDT may have a smaller UL grant and/or a shorter latency than a CG resource configured for MO-SDT. In some embodiments, the terminal device 110 may receive, from the network device 120, a configuration (for convenience, also referred to as a third configuration herein) indicating the dedicated CG resource for MT-SDT.

If the dedicated CG resource for MT-SDT is available, the process 700A proceeds to block 711. At block 711, the terminal device 110 may determine that the CG based MT-SDT is performed for the terminal device 110.

If no dedicated CG resource for MT-SDT is available, the process 700A proceeds to block 712. At block 712, the terminal device 110 may determine that the RA based MT-SDT is performed for the terminal device 110.

With the solution of Embodiment 5, waste of UL grants may be avoided and possibility of a successful transmission may also be improved.

### Embodiment 6

This embodiment is an alternative for Embodiment 5. This embodiment will be described with reference to FIG. 7B.

FIG. 7B illustrates a flowchart illustrating an example process 700B of determining a MT-SDT procedure according to Embodiment 6 of the present disclosure. For example, the method 700B may be performed at the terminal device 110 as shown in FIG. 1. For the purpose of discussion, in the following, the method 700B will be described with reference to FIG. 1. It is to be understood that the method 700B may include additional blocks not shown and/or may omit some blocks as shown, and the scope of the present disclosure is not limited in this regard. Assuming that the CG based MT-SDT is determined to be performed for the terminal device 110.

As shown in FIG. 7B, at block 720, the terminal device 110 may determine a transmission configuration from a set of transmission configurations for the CG based MT-SDT. In some embodiments, the transmission configuration may comprise at least one of a modulation order, a target code rate, or a transport block (TB) size. For example, the transmission configuration may be in form of a TBSandMCS configuration or any other suitable forms.

In some embodiments, the terminal device 110 may receive, from the network device 120, the set of transmission configurations in a RRC release message. The terminal device 110 may select suitable a transmission configuration from the set of transmission configurations when triggering the CG-based MT-SDT. For example, the terminal device 110 may perform the selection based on a size of data of an initial UL transmission of MT-SDT. Of course, any other suitable ways are also possible for the selection. In some embodiments where the set of transmission configurations comprises a single transmission configuration for MT-SDT, the terminal device 110 may use the single transmission configuration for the CG-based MT-SDT.

At block 721, the terminal device 110 may perform the CG based MT-SDT based on the determined transmission configuration. In some embodiments, the terminal device 110 may indicate the determined transmission configuration to the network device 120 by UCI piggybacked with initial UL transmission of the CG based MT-SDT.

With the solution of Embodiment 6, waste of UL grants may also be avoided and possibility of a successful transmission may also be improved.

### Embodiment 7

This embodiment also is an alternative for Embodiment 5. This embodiment will be described with reference to FIG. 7C.

FIG. 7C illustrates a flowchart illustrating an example process 700C of determining a MT-SDT procedure according to Embodiment 7 of the present disclosure. For example, the method 700C may be performed at the terminal device 110 as shown in FIG. 1. For the purpose of discussion, in the following, the method 700C will be described with reference to FIG. 1. It is to be understood that the method 700C may include additional blocks not shown and/or may omit some blocks as shown, and the scope of the present disclosure is not limited in this regard. Assuming that the RA based MT-SDT is determined to be performed for the terminal device 110.

As shown in FIG. 7C, at block 730, the terminal device 110 may determine whether a dedicated RA resource for MT-SDT is available. In some embodiments, the dedicated RA resource for MT-SDT may have a smaller UL grant and/or a shorter latency than a RA resource configured for MO-SDT. In some embodiments, the terminal device 110 may receive, from the network device 120, a configuration (for convenience, also referred to as a fourth configuration herein) indicating the dedicated RA resource for MT-SDT.

If the dedicated RA resource for MT-SDT is available, the process 700C proceeds to block 731. At block 731, the terminal device 110 may determine that the RA based MT-SDT is performed for the terminal device 110. That is, the terminal device 110 may only select dedicated RA resource for MT-SDT. In some embodiments, if no dedicated RA resource for MT-SDT is available, the terminal device 110 may determine that a MO-SDT or a non-SDT procedure is performed for the terminal device 110.

With the solution of Embodiment 7, waste of UL grants may also be avoided and possibility of a successful transmission may also be improved.

So far, some example embodiments of the determination 320 of the MT-SDT procedure are described. Return to FIG. 3, based on the determination 320, the terminal device 110 performs 330 the MT-SDT procedure via a RA or CG resource. In some embodiments, if the terminal device 110 determines that the RA based MT-SDT is performed, the terminal device 110 may perform the initial UL transmission of the MT-SDT via a RA resource. If the terminal device 110 determines that the CG based MT-SDT is performed, the terminal device 110 may perform the initial UL transmission of the MT-SDT via a CG resource.

In some embodiments, the terminal device 110 may perform the initial UL transmission by transmitting a RRC resume request message to the network device 120. In some embodiments, the RRC resume request message may comprise an indication (for convenience, also referred to as a second indication herein) indicating the MT-SDT. In some alternative embodiments, the RRC resume request message may not comprise the second indication.

In some scenarios, when the terminal device 110 goes into an inactive state after reception of RRC release message with suspended configuration, there could be UL packets buffered (i.e., buffered data) in the terminal device 110 which are not successfully transmitted to the network device 120. Thus, whether the buffered data is transmitted together with the initial UL transmission of the MT-SDT becomes an issue.

In some embodiments, upon triggering of MT-SDT, the terminal device 110 resumes radio bearers configured with SDT, perform PDCP re-establishment and RLC re-establishment for the PDCP entities and RLC entities of radio bearers configured with SDT, and the buffered data may be caused to be not transmitted together with the initial UL transmission of the MT-SDT. In some embodiments, the terminal device 110 may allocate 331, by a MAC layer of the terminal device 110, an UL resource for a SRB (for example, SRB0) for the initial UL transmission. In other words, the terminal device 110 may not allocate an UL resource for radio bearers other than SRB0 for the initial UL transmission of the MT-SDT. In these embodiments, the terminal device 110 may allocate, by the MAC layer, a resource for radio bearers other than the SRB0 for subsequent transmission of the MT-SDT. The radio bearers are configured with SDT and are not suspended.

In some alternative embodiments, the terminal device 110 may determine 332 whether the initial uplink transmission is performed successfully. If the initial uplink transmission is performed successfully, the terminal device 110 may resume 333 a set of radio bearers configured with SDT, and perform PDCP re-establishment and RLC re-establishments for the PDCP entities and RLC entities of the set of radio bearers. For example, the terminal device 110 may resume the set of radio bearers configured with SDT and perform the PDCP re-establishment and RLC re-establishments for the PDCP entities and RLC entities of the set of radio bearers after the MAC layer indicates a successful completion of a RA procedure for MT-SDT or after the MAC layer indicates a successful CG transmission.

In this way, the buffered data is not transmitted in the initial UL transmission of the MT-SDT. Thus, bits of data to be transmitted may be saved, and it becomes easier for the terminal device 110 to resume a RRC connection with the network device 120 successfully.

Alternatively, the buffered data may be caused to be transmitted together with the initial UL transmission of the MT-SDT. In these embodiments, the terminal device 110 may allocate, by the MAC layer, a resource for both SRB0 and other radio bearers (configured with SDT and not suspended) for the initial UL transmission of the MT-SDT. The terminal device 110 may also allocate, by the MAC layer, a resource for radio bearers (configured with SDT and not suspended) during the subsequent transmission of the MT-SDT. In this way, the buffered data may be transmitted with the initial UL transmission of the MT-SDT.

Continue to with reference to FIG. 3, upon reception of the initial UL transmission, the network device 120 may transmit 335, to the network device 130, a request for obtaining a context of the terminal device 110. The request comprises an indication (for convenience, also referred to as a third indication herein) indicating that the MT-SDT is performed for the terminal device 110. For example, the network device 120 may transmit the request in a retrieve UE context request message. Of course, any other suitable ways are also feasible.

Based on the presence or absence of the third indication, the network device 130 may be aware whether the request is for MT-SDT purpose, and then may decide whether to perform anchor relocation or not. In some embodiments, the network device 130 may transmit 335′ the context of the terminal device 110 to the network device 120.

Upon reception of the initial UL transmission, e.g., a RRC resume request message indicating MT-SDT, the network device 120 may response to the terminal device 110 in any suitable ways. In some embodiments, the network device 120 may transmit 340, to the terminal device 110, a RRC release message with DL data. In some embodiments, the network device 120 may transmit 350 a RRC resume message to the terminal device 110. In some embodiments, the network device 120 may transmit 360 a RRC reject message to the terminal device 110. In some embodiments, the network device 120 may transmit 370 a RRC setup message to the terminal device 110.

In some embodiments, the network device 120 may transmit 380 DL data to the terminal device 110 while performing subsequent transmission with the terminal device 110. For example, the network device 120 may transmit 381 DL data to the terminal device 110. The terminal device 110 may transmit 382 UL data to the network device 120. The network device 120 may transmit 383 a RRC release message with DL data to the terminal device 110. Then the MT-SDT procedure ends.

### Example Implementation of Methods

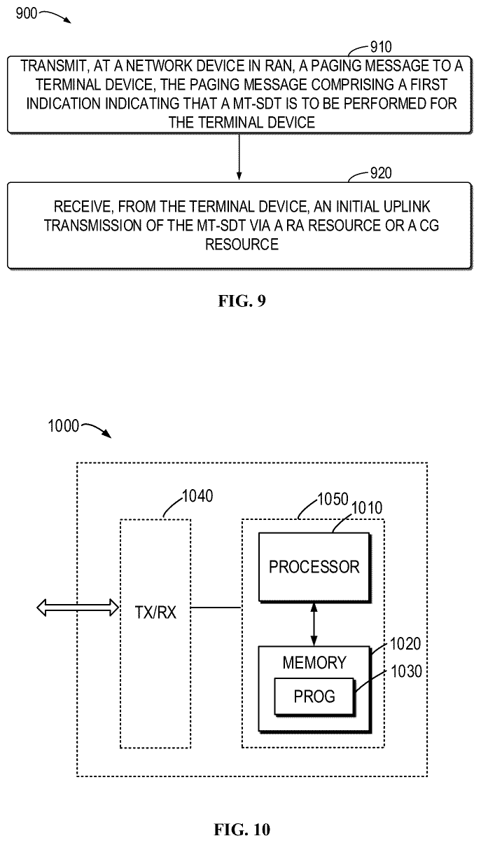

Accordingly, embodiments of the present disclosure provide methods of communication implemented at a terminal device and a network device. These methods will be described below with reference to FIGS. 8 to 9.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 receives, from the network device 120 in RAN, a paging message comprising a first indication indicating that a MT-SDT is to be performed for the terminal device 110.

At block 820, the terminal device 110 determines whether a RA based MT-SDT or a CG based MT-SDT is performed for the terminal device 110. In some embodiments, the terminal device 110 may indicate, by a RRC layer of the terminal device 110 to a MAC layer of the terminal device 110, that the MT-SDT is triggered, and determine, by the MAC layer, whether the RA based MT-SDT or the CG based MT-SDT is performed for the terminal device 110.

In some embodiments, the terminal device 110 may determine whether a CG resource is available for SDT. If the CG resource is available for SDT, the terminal device 110 may determine that the CG based MT-SDT is performed for the terminal device 110. If no CG resource is available for SDT, the terminal device 110 may determine that the RA based MT-SDT is performed for the terminal device 110.

In some embodiments, the terminal device 110 may determine a first time interval between a time of a triggering of the MT-SDT and a time of a next CG resource available for SDT. If the first time interval is smaller than or equal to a first threshold interval, the terminal device 110 may determine that the CG based MT-SDT is performed for the terminal device 110. If the first time interval is greater than the first threshold interval, the terminal device 110 may determine that the RA based MT-SDT is performed for the terminal device 110. In some embodiments, the terminal device 110 may receive, from the network device 120, a first configuration indicating the first threshold interval.

In some embodiments, if the RA based MT-SDT is performed for the terminal device 110, the terminal device 110 may store information on the CG based MT-SDT not performed for the terminal device 110, and report the stored information to the network device 120. In some embodiments, the information may comprise at least one of the following: the first time interval being greater than the first threshold interval; or the first time interval.

In some embodiments, the terminal device 110 may determine a first time interval between a time of a triggering of the MT-SDT and a time of a next CG resource available for SDT and determine a second time interval between the time of the triggering of the MT-SDT and a time of a next RA resource available for SDT. If the first time interval is smaller than or equal to the second time interval, the terminal device 110 may determine that the CG based MT-SDT is performed for the terminal device 110. If the first time interval is greater than the second time interval, the terminal device 110 may determine that the RA based MT-SDT is performed for the terminal device 110.

In some embodiments, if the RA based MT-SDT is performed for the terminal device 110, the terminal device 110 may determine a third time interval between a time of a triggering of the MT-SDT and a time of a next RA resource available for SDT. If the third time interval is smaller than or equal to a second threshold interval, the terminal device 110 may perform the RA based MT-SDT based on a first RA configuration for SDT. The first RA configuration may comprise the next RA resource available for SDT. If the third time interval is greater than the second threshold interval, the terminal device 110 may perform the RA based MT-SDT based on a second RA configuration for non-SDT. In some embodiments, the terminal device 110 may receive, from the network device 120, a second configuration indicating the second threshold interval.

In some embodiments, if the RA based MT-SDT is performed for the terminal device 110, the terminal device 110 may determine a third time interval between a time of a triggering of the MT-SDT and a time of a next RA resource available for SDT, and determine a fourth time interval between the time of the triggering of the MT-SDT and a time of a next RA resource available for non-SDT. If the third time interval is smaller than or equal to the fourth time interval, the terminal device 110 may perform the RA based MT-SDT based on a first RA configuration for SDT. The first RA configuration may comprise the next RA resource available for SDT. If the third time interval is greater than the fourth threshold interval, the terminal device 110 may perform the RA based MT-SDT based on a second RA configuration for non-SDT. The second RA configuration may comprise the next RA resource available for non-SDT.

In some embodiments, the terminal device 110 may determine whether a dedicated CG resource for MT-SDT is available. If the dedicated CG resource is available, the terminal device 110 may determine that the CG based MT-SDT is performed for the terminal device 110. If no dedicated CG resource is available, the terminal device 110 may determine that the RA based MT-SDT is performed for the terminal device 110. In some embodiments, the terminal device 110 may receive, from the network device 120, a third configuration indicating the dedicated CG resource.

In some embodiments, if the CG based MT-SDT is performed for the terminal device 110, the terminal device 110 may determine a transmission configuration from a set of transmission configurations for the CG based MT-SDT, and perform the CG based MT-SDT based on the determined transmission configuration. In some embodiments, the transmission configuration may comprise at least one of a modulation order, a target code rate, or a TB size. In some embodiments, the terminal device 110 may receive, from the network device 120, the set of transmission configurations in a RRC release message.

In some embodiments, if the RA based MT-SDT is performed for the terminal device 110, the terminal device 110 may determine whether a dedicated RA resource for MT-SDT is available. If the dedicated RA resource is available, the terminal device 110 may perform the RA based MT-SDT based on the dedicated RA resource. In some embodiments, the terminal device 110 may receive, from the network device 120, a fourth configuration indicating the dedicated RA resource.

In some embodiments, if the RA based MT-SDT is performed for the terminal device 110, the terminal device 110 may perform an initial uplink transmission of the MT-SDT to the network device 120 via a RA resource. In some embodiments, if the CG based MT-SDT is performed for the terminal device 110, the terminal device 110 may perform the initial uplink transmission to the network device 120 via a CG resource.

In some embodiments, the terminal device 110 may receive, from the network device 120, a RRC release message with DL data. In some embodiments, the terminal device 110 may receive, from the network device 120, a RRC resume message. In some embodiments, the terminal device 110 may receive, from the network device 120, a RRC reject message. In some embodiments, the terminal device 110 may receive, from the network device 120, a RRC setup message. In some embodiments, the terminal device 110 may receive DL data from the network device 120 while performing subsequent transmission with the network device 120.

In some embodiments, the terminal device 110 may perform the initial uplink transmission by: allocating, by a MAC layer of the terminal device 110, an UL resource for a SRB for the initial uplink transmission, the initial uplink transmission comprising a transmission of a RRC resume request message. In some embodiments, the RRC resume request message comprises a second indication indicating the MT-SDT. In some embodiments, the terminal device 110 may also allocate, by the MAC layer, a resource for radio bearers other than the SRB for subsequent transmission of the MT-SDT.

In some embodiments, the terminal device 110 may determine whether the initial UL transmission is performed successfully. If the initial UL transmission is performed successfully, the terminal device 110 may resume a set of radio bearers configured with SDT, and perform PDCP and RLC re-establishments for the set of radio bearers.

FIG. 9 illustrates an example method 900 of communication implemented at a network device serving a terminal device in accordance with some embodiments of the present disclosure. For example, the method 900 may be performed at the network device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the network device 120 transmits a paging message to the terminal device 110. The paging message comprises a first indication indicating that a MT-SDT is to be performed for the terminal device 110.

At block 920, the network device 120 receives, from the terminal device 110, an initial UL transmission of the MT-SDT via a RA resource or a CG resource. In some embodiments, the network device 120 may receive, from the terminal device 110, a RRC resume request message comprising a second indication indicating the MT-SDT.

In some embodiments, the network device 120 may transmit, to the terminal device 110, a RRC release message with DL data. In some embodiments, the network device 120 may transmit, to the terminal device 110, a RRC resume message. In some embodiments, the network device 120 may transmit, to the terminal device 110, a RRC reject message. In some embodiments, the network device 120 may transmit, to the terminal device 110, a RRC setup message. In some embodiments, the network device 120 may transmit DL data to the terminal device 110 while performing subsequent transmission with the terminal device 110.

In some embodiments, the network device 120 may transmit, to the terminal device 110, a first configuration indicating a first threshold interval for determination of a CG based MT-SDT. In some embodiments, the network device 120 may transmit, to the terminal device 110, a second configuration indicating a second threshold interval for determination of a RA based MT-SDT.

In some embodiments, the network device 120 may receive, from the terminal device 110, information on the CG based MT-SDT not performed for the terminal device 110. In some embodiments, the information may comprise at least one of the following: the first time interval being greater than the first threshold interval; or the first time interval.

In some embodiments, the network device 120 may transmit, to the terminal device 110 in a RRC release message, a set of transmission configurations for a CG based MT-SDT. In some embodiments, the transmission configuration may comprise at least one of a modulation order, a target code rate, or a TB size.

In some embodiments, the network device 120 may transmit, to the terminal device 110, a third configuration indicating a dedicated CG resource for the MT-SDT. In some embodiments, the network device 120 may transmit, to the terminal device 110, a fourth configuration indicating a dedicated RA resource for the MT-SDT.

In some embodiments, the network device 120 may transmit, to a further network device (for example, the network device 130), a request for obtaining a context of the terminal device 110, the request comprising a third indication indicating that the MT-SDT is performed for the terminal device 110.

In this way, a MT-SDT procedure is performed. The implementations of the methods described in FIGS. 8 and 9 substantially correspond to that described with reference to FIGS. 3 to 7C, and thus other details are not repeated here.

### Example Implementation of Device and Apparatus

FIG. 10 is a simplified block diagram of a device 1000 that is suitable for implementing embodiments of the present disclosure. The device 1000 can be considered as a further example implementation of the terminal device 110 or the network device 120 as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to: receive a paging message from a network device in a radio access network, the paging message comprising a first indication indicating that a MT-SDT is to be performed for the terminal device; and determine whether a random access based MT-SDT or a configured grant based MT-SDT is performed for the terminal device.

In some embodiments, the circuitry may be configured to: indicate, by a radio resource control layer of the terminal device to a medium access control layer of the terminal device, that the MT-SDT is triggered; and determine, by the medium access control layer, whether the random access based MT-SDT or the configured grant based MT-SDT is performed for the terminal device.

In some embodiments, the circuitry may be configured to: determine whether a configured grant resource is available for SDT; in accordance with a determination that the configured grant resource is available for SDT, determine that the configured grant based MT-SDT is performed for the terminal device; and in accordance with a determination that no configured grant resource is available for SDT, determine that the random access based MT-SDT is performed for the terminal device.

In some embodiments, the circuitry may be configured to: determine a first time interval between a time of a triggering of the MT-SDT and a time of a next configured grant resource available for SDT; in accordance with a determination that the first time interval is smaller than or equal to a first threshold interval, determining that the configured grant based MT-SDT is performed for the terminal device; and in accordance with a determination that the first time interval is greater than the first threshold interval, determining that the random access based MT-SDT is performed for the terminal device. In some embodiments, the circuitry may be further configured to receive, from the network device, a first configuration indicating the first threshold interval.

In some embodiments, the circuitry may be further configured to: in accordance with a determination that the random access based MT-SDT is performed for the terminal device, store information on the configured grant based MT-SDT not performed for the terminal device; and report the information to the network device. In some embodiments, the information comprises at least one of the following: the first time interval being greater than the first threshold interval; or the first time interval.

In some embodiments, the circuitry may be configured to: determine a first time interval between a time of a triggering of the MT-SDT and a time of a next configured grant resource available for SDT; determining a second time interval between the time of the triggering of the MT-SDT and a time of a next random access resource available for SDT; in accordance with a determination that the first time interval is smaller than or equal to the second time interval, determining that the configured grant based MT-SDT is performed for the terminal device; and in accordance with a determination that the first time interval is greater than the second time interval, determining that the random access based MT-SDT is performed for the terminal device.

In some embodiments, the circuitry may be further configured to: in accordance with a determination that the random access based MT-SDT is performed for the terminal device, determine a third time interval between a time of a triggering of the MT-SDT and a time of a next random access resource available for SDT; in accordance with a determination that the third time interval is smaller than or equal to a second threshold interval, perform the random access based MT-SDT based on a first random access configuration for SDT; and in accordance with a determination that the third time interval is greater than the second threshold interval, perform the random access based MT-SDT based on a second random access configuration for non-SDT. In some embodiments, the circuitry may be further configured to receive, from the network device, a second configuration indicating the second threshold interval.

In some embodiments, the circuitry may be further configured to: in accordance with a determination that the random access based MT-SDT is performed for the terminal device, determine a third time interval between a time of a triggering of the MT-SDT and a time of a next random access resource available for SDT; determine a fourth time interval between the time of the triggering of the MT-SDT and a time of a next random access resource available for non-SDT; in accordance with a determination that the third time interval is smaller than or equal to the fourth time interval, perform the random access based MT-SDT based on a first random access configuration for SDT; and in accordance with a determination that the third time interval is greater than the fourth threshold interval, perform the random access based MT-SDT based on a second random access configuration for non-SDT.

In some embodiments, the circuitry may be configured to: determine whether a dedicated configured grant resource for MT-SDT is available; in accordance with a determination that the dedicated configured grant resource is available, determine that the configured grant based MT-SDT is performed for the terminal device; and in accordance with a determination that no dedicated configured grant resource is available, determine that the random access based MT-SDT is performed for the terminal device. In some embodiments, the circuitry may be further configured to receive, from the network device, a third configuration indicating the dedicated configured grant resource.

In some embodiments, the circuitry may be further configured to: in accordance with a determination that the configured grant based MT-SDT is performed for the terminal device, determine a transmission configuration from a set of transmission configurations for the configured grant based MT-SDT; and perform the configured grant based MT-SDT based on the determined transmission configuration. In some embodiments, the transmission configuration comprises at least one of a modulation order, a target code rate, or a transport block size. In some embodiments, the circuitry may be further configured to: receive, from the network device, the set of transmission configurations in a radio resource control release message.

In some embodiments, the circuitry may be further configured to: in accordance with a determination that the random access based MT-SDT is performed for the terminal device, determine whether a dedicated random access resource for MT-SDT is available; and in accordance with a determination that the dedicated random access resource is available, perform the random access based MT-SDT based on the dedicated random access resource. In some embodiments, the circuitry may be further configured to receive, from the network device, a fourth configuration indicating the dedicated random access resource.

In some embodiments, the circuitry may be further configured to: in accordance with a determination that the random access based MT-SDT is performed for the terminal device, perform an initial uplink transmission of the MT-SDT to the network device via a random access resource; or in accordance with a determination that the configured grant based MT-SDT is performed for the terminal device, perform the initial uplink transmission to the network device via a configured grant resource.

In some embodiments, the circuitry may be further configured to: receive, from the network device, a radio resource control release message with downlink data; receiving, from the network device, a radio resource control resume message; receiving, from the network device, a radio resource control reject message; receiving, from the network device, a radio resource control setup message; or receiving downlink data from the network device while performing subsequent transmission with the network device.

In some embodiments, the circuitry may be configured to perform the initial uplink transmission by: allocating, by a medium access control layer of the terminal device, an uplink resource for a signaling radio bearer for the initial uplink transmission, the initial uplink transmission comprising a transmission of a radio resource control resume request message. In some embodiments, the radio resource control resume request message comprises a second indication indicating the MT-SDT. In some embodiments, the circuitry may be further configured to allocate, by the medium access control layer, a resource for radio bearers other than the signaling radio bearer for subsequent transmission of the MT-SDT.

In some embodiments, the circuitry may be further configured to: determine whether the initial uplink transmission is performed successfully; and in accordance with a determination that the initial uplink transmission is performed successfully, resume a set of radio bearers configured with SDT; and perform PDCP and RLC re-establishments for the set of radio bearers.

In some embodiments, a network device comprises a circuitry configured to: transmit a paging message to a terminal device, the paging message comprising a first indication indicating that a MT-SDT is to be performed for the terminal device; and receive, from the terminal device, an initial uplink transmission of the MT-SDT via a random access resource or a configured grant resource.

In some embodiments, the circuitry may be configured to receive the initial uplink transmission by receiving, from the terminal device, a radio resource control resume request message comprising a second indication indicating the MT-SDT.

In some embodiments, the circuitry may be further configured to: transmit, to the terminal device, a radio resource control release message with downlink data; transmit, to the terminal device, a radio resource control resume message; transmit, to the terminal device, a radio resource control reject message; transmit, to the terminal device, a radio resource control setup message; or transmit downlink data to the terminal device while performing subsequent transmission with the terminal device.

In some embodiments, the circuitry may be further configured to at least one of the following: transmit, to the terminal device, a first configuration indicating a first threshold interval for determination of a configured grant based MT-SDT; or transmit, to the terminal device, a second configuration indicating a second threshold interval for determination of a random access based MT-SDT.

In some embodiments, the circuitry may be further configured to receive, from the terminal device, information on the configured grant based MT-SDT not performed for the terminal device. In some embodiments, the information comprises at least one of the following: the first time interval being greater than the first threshold interval; or the first time interval.

In some embodiments, the circuitry may be further configured to transmit, to the terminal device in a radio resource control release message, a set of transmission configurations for a configured grant based MT-SDT. In some embodiments, the transmission configuration comprises at least one of a modulation order, a target code rate, or a transport block size.

In some embodiments, the circuitry may be further configured to at least one of the following: transmit, to the terminal device, a third configuration indicating a dedicated configured grant resource for the MT-SDT; or transmit, to the terminal device, a fourth configuration indicating a dedicated random access resource for the MT-SDT.

In some embodiments, the circuitry may be further configured to transmit, to a further network device, a request for obtaining a context of the terminal device, the request comprising a third indication indicating that the MT-SDT is performed for the terminal device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a terminal device, a paging message from a network device in a radio access network, the paging message comprising a first indication indicating that a mobile-terminated small data transmission, MT-SDT, is to be performed for the terminal device; and
determining whether a random access based MT-SDT or a configured grant based MT-SDT is performed for the terminal device.

2. The method of claim 1, wherein the determining comprises:
indicating, by a radio resource control layer of the terminal device to a medium access control layer of the terminal device, that the MT-SDT is triggered; and
determining, by the medium access control layer, whether the random access based MT-SDT or the configured grant based MT-SDT is performed for the terminal device.

3. The method of claim 1, wherein the determining comprises:
determining whether a configured grant resource is available for small data transmission, SDT;
in accordance with a determination that the configured grant resource is available for SDT, determining that the configured grant based MT-SDT is performed for the terminal device; and
in accordance with a determination that no configured grant resource is available for SDT, determining that the random access based MT-SDT is performed for the terminal device.

4. The method of claim 1, wherein the determining comprises:
determining a first time interval between a time of a triggering of the MT-SDT and a time of a next configured grant resource available for SDT;
in accordance with a determination that the first time interval is smaller than or equal to a first threshold interval, determining that the configured grant based MT-SDT is performed for the terminal device; and
in accordance with a determination that the first time interval is greater than the first threshold interval, determining that the random access based MT-SDT is performed for the terminal device.

5. The method of claim 4, further comprising:
receiving, from the network device, a first configuration indicating the first threshold interval.

6. The method of claim 4, further comprising:
in accordance with a determination that the random access based MT-SDT is performed for the terminal device, storing information on the configured grant based MT-SDT not performed for the terminal device; and
reporting the information to the network device.

7. The method of claim 6, wherein the information comprises at least one of the following:
the first time interval being greater than the first threshold interval; or
the first time interval.

8. The method of claim 1, wherein the determining comprises:
determining a first time interval between a time of a triggering of the MT-SDT and a time of a next configured grant resource available for SDT;
determining a second time interval between the time of the triggering of the MT-SDT and a time of a next random access resource available for SDT;
in accordance with a determination that the first time interval is smaller than or equal to the second time interval, determining that the configured grant based MT-SDT is performed for the terminal device; and
in accordance with a determination that the first time interval is greater than the second time interval, determining that the random access based MT-SDT is performed for the terminal device.

9. The method of claim 1, further comprising:
in accordance with a determination that the random access based MT-SDT is performed for the terminal device, determining a third time interval between a time of a triggering of the MT-SDT and a time of a next random access resource available for SDT;
in accordance with a determination that the third time interval is smaller than or equal to a second threshold interval, performing the random access based MT-SDT based on a first random access configuration for SDT; and
in accordance with a determination that the third time interval is greater than the second threshold interval, performing the random access based MT-SDT based on a second random access configuration for non-SDT.

10. The method of claim 9, further comprising:
receiving, from the network device, a second configuration indicating the second threshold interval.

11. The method of claim 1, further comprising:
in accordance with a determination that the random access based MT-SDT is performed for the terminal device, determining a third time interval between a time of a triggering of the MT-SDT and a time of a next random access resource available for SDT;
determining a fourth time interval between the time of the triggering of the MT-SDT and a time of a next random access resource available for non-SDT;
in accordance with a determination that the third time interval is smaller than or equal to the fourth time interval, performing the random access based MT-SDT based on a first random access configuration for SDT; and
in accordance with a determination that the third time interval is greater than the fourth threshold interval, performing the random access based MT-SDT based on a second random access configuration for non-SDT.

12. The method of claim 1, wherein the determining comprises:
determining whether a dedicated configured grant resource for MT-SDT is available;
in accordance with a determination that the dedicated configured grant resource is available, determining that the configured grant based MT-SDT is performed for the terminal device; and
in accordance with a determination that no dedicated configured grant resource is available, determining that the random access based MT-SDT is performed for the terminal device.

13. The method of claim 12, further comprising:
receiving, from the network device, a third configuration indicating the dedicated configured grant resource.

14. The method of claim 1, further comprising:
in accordance with a determination that the configured grant based MT-SDT is performed for the terminal device, determining a transmission configuration from a set of transmission configurations for the configured grant based MT-SDT; and
performing the configured grant based MT-SDT based on the determined transmission configuration.

15. The method of claim 14, wherein the transmission configuration comprises at least one of a modulation order, a target code rate, or a transport block size.

16. The method of claim 14, further comprising:
receiving, from the network device, the set of transmission configurations in a radio resource control release message.

17. The method of claim 1, further comprising:
in accordance with a determination that the random access based MT-SDT is performed for the terminal device, determining whether a dedicated random access resource for MT-SDT is available; and
in accordance with a determination that the dedicated random access resource is available, performing the random access based MT-SDT based on the dedicated random access resource.

18. The method of claim 17, further comprising:
receiving, from the network device, a fourth configuration indicating the dedicated random access resource.

19. The method of claim 1, further comprising:
in accordance with a determination that the random access based MT-SDT is performed for the terminal device, performing an initial uplink transmission of the MT-SDT to the network device via a random access resource; or
in accordance with a determination that the configured grant based MT-SDT is performed for the terminal device, performing the initial uplink transmission to the network device via a configured grant resource.

20. The method of claim 19, further comprising:
receiving, from the network device, a radio resource control release message with downlink data;
receiving, from the network device, a radio resource control resume message;
receiving, from the network device, a radio resource control reject message;
receiving, from the network device, a radio resource control setup message; or
receiving downlink data from the network device while performing subsequent transmission with the network device.

21. The method of claim 19, wherein performing the initial uplink transmission comprises:
allocating, by a medium access control layer of the terminal device, an uplink resource for a signaling radio bearer for the initial uplink transmission, the initial uplink transmission comprising a transmission of a radio resource control resume request message.

22. The method of claim 21, wherein the radio resource control resume request message comprises a second indication indicating the MT-SDT.

23. The method of claim 21, further comprising:
allocating, by the medium access control layer, a resource for radio bearers other than the signaling radio bearer for subsequent transmission of the MT-SDT.

24. The method of claim 19, further comprising:
determining whether the initial uplink transmission is performed successfully; and
in accordance with a determination that the initial uplink transmission is performed successfully,
resuming a set of radio bearers configured with SDT; and
performing packet data convergence protocol (PDCP) and radio link control (RLC) re-establishments for the set of radio bearers.

25. A method of communication, comprising:
transmitting, at a network device in a radio access network, a paging message to a terminal device, the paging message comprising a first indication indicating that a mobile-terminated small data transmission, MT-SDT, is to be performed for the terminal device; and
receiving, from the terminal device, an initial uplink transmission of the MT-SDT via a random access resource or a configured grant resource.

26. The method of claim 25, wherein receiving the initial uplink transmission comprises:
receiving, from the terminal device, a radio resource control resume request message comprising a second indication indicating the MT-SDT.

27. The method of claim 25, further comprising:
transmitting, to the terminal device, a radio resource control release message with downlink data;
transmitting, to the terminal device, a radio resource control resume message;
transmitting, to the terminal device, a radio resource control reject message;
transmitting, to the terminal device, a radio resource control setup message; or
transmitting downlink data to the terminal device while performing subsequent transmission with the terminal device.

28. The method of claim 25, further comprising at least one of the following:
transmitting, to the terminal device, a first configuration indicating a first threshold interval for determination of a configured grant based MT-SDT; or
transmitting, to the terminal device, a second configuration indicating a second threshold interval for determination of a random access based MT-SDT.

29. The method of claim 28, further comprising:
receiving, from the terminal device, information on the configured grant based MT-SDT not performed for the terminal device.

30. The method of claim 29, wherein the information comprises at least one of the following:
the first time interval being greater than the first threshold interval; or
the first time interval.

31. The method of claim 25, further comprising:
transmitting, to the terminal device in a radio resource control release message, a set of transmission configurations for a configured grant based MT-SDT.

32. The method of claim 31, wherein the transmission configuration comprises at least one of a modulation order, a target code rate, or a transport block size.

33. The method of claim 25, further comprising at least one of the following:
transmitting, to the terminal device, a third configuration indicating a dedicated configured grant resource for the MT-SDT; or
transmitting, to the terminal device, a fourth configuration indicating a dedicated random access resource for the MT-SDT.

34. The method of claim 25, further comprising:
transmitting, to a further network device, a request for obtaining a context of the terminal device, the request comprising a third indication indicating that the MT-SDT is performed for the terminal device.

35. A terminal device comprising:
a processor configured to perform the method according to any of claims 1 to 24.

36. A network device comprising:
a processor configured to perform the method according to any of claims 25 to 34.
